(19) United States
(12) Patent Application Publication
(10) Pub. No.: US 2015/0282650 A1
(43) Pub. Date: Oct. 8, 2015

(54) APPARATUS FOR DISGUISING LIQUID CONTENTS IN POSSESSION

(71) Applicants: Jane Cusick, Fountain Valley, CA (US); Debbie Kay Mende, Oceanside, CA (US)

(72) Inventors: Jane Cusick, Fountain Valley, CA (US); Debbie Kay Mende, Oceanside, CA (US)

(21) Appl. No.: 14/243,572

(22) Filed: Apr. 2, 2014

(51) Int. Cl. A47G 19/22; B67C 11/02

(52) U.S. Cl. CPC A47G 19/2205; B67C 11/02; A47G 2019/2277

(57) ABSTRACT

A device in the form of a container is disclosed which obscures and/or misdirects another person from recognizing the device contains potable fluid. The device is generally constructed with the appearance of a cosmetics-style tube and, in the illustrated form, a sunscreen lotion tube. The device includes a neck and a removable cap that are matingly threaded as to be sealingly engaged to prevent leakage, and the device is finable by a loading device styled as a funnel.

### CROSS-REFERENCE TO RELATED APPLICATION(S)

This application claims the benefit of U.S. Provisional Application No. 61/807,366, filed Apr. 2, 2013, the entirety of which is incorporated by reference herein.

### FIELD OF THE INVENTION

The invention relates to a device or apparatus for holding potable fluids and for disguising the nature of the fluid and, in particular, to flask-like apparatus for containing and transporting potable fluid while giving the appearance of containing or being something other than a flask.

### BACKGROUND

Currently, many containers are known for storing, transporting, and permitting dispensing of fluids. The range of such containers includes large water coolers, sport bottles, flasks, and original containers such as liquor or soda bottles. The common denominator for many of these containers is that it is immediately apparent to another person that such either hold or likely hold potable liquid.

Of course, in most instances people are not concerned with others being aware that a possessed container indeed suggests possession of a liquid. As an example, a person working out in a gym would almost be expected to possess a sport bottle, and few would expect that bottle to contain anything other than water or a sport drink.

It is known to have a re-usable container for possessing and transporting a relatively small amount of liquid. That is, it is known to have so-called travel-sized mouthwash containers, and it is known to have a flask for liquor poured from a larger bottle so that a person may carry just the flask. However, these devices typically clearly display that they are in fact devices for carrying potable fluid.

In some instances, it is undesirable for others to know that potable liquid is possessed. For instance, a person prone to low blood sugar may carry a candy bar, but may also like to carry a sugary drink: such person may rather not have to explain to an inquiring person why they are carrying a flask and what the contents are. Another person may be taking regular doses of oral liquid medicine and may not want others being aware that they require such. In another example, a person may want to imbibe alcoholic beverages in a place in which such is permitted, yet not want others to know they are doing so: for instance, people may be wary of setting a poor example for children by bringing along a flask or liquor bottle to a picnic and thus would rather others not recognize that alcoholic beverages are possessed. The difficulty in such cases is that most devices for containing and possessing potable fluids are identifiable as being exactly that.

Accordingly, there has been a need for an improved device for containing, storing, transporting, and dispensing of potable fluids.

### SUMMARY

In accordance with an aspect of the invention, a device for containing, storing, transporting, and dispensing of potable fluids, wherein said device disguises the contents thereof. In the present form, the device presents itself as a cosmetics tube and, specifically, as a cosmetics tube of sunscreen lotion.

### BRIEF DESCRIPTION OF THE DRAWINGS

In the Figures, FIG. 1 is a top plan image of a form of the present invention serving a container for potable fluid, the Fig. depicting a cosmetic-style device as a tube having a closed end and an openable end with a threaded neck for sealingly engaging with a cap, the device including external artwork disguising the contents of the container and misdirecting an observer to believe the container is a tube of sunscreen lotion;

FIG. 2 is a perspective view of the openable end of the device of FIG. 1 showing an opening for receiving and dispensing fluid, the opening in communication with an internal volume defined by the neck and the tube body;

FIG. 3 is a perspective view of the device of FIG. 1 with a cap secured to the openable end;

FIG. 4 is a perspective view of the cap;

FIG. 5 is a perspective view of the cap showing a wall with internal threads for mating with threads of the neck and an internal wall for engaging with an end wall of the neck;

FIG. 6 is a top plan view of the cap;

FIG. 7 is a perspective view of a funnel for loading fluid into the device of the preceding Figs.; and

FIG. 8 is a plan view of the artwork.

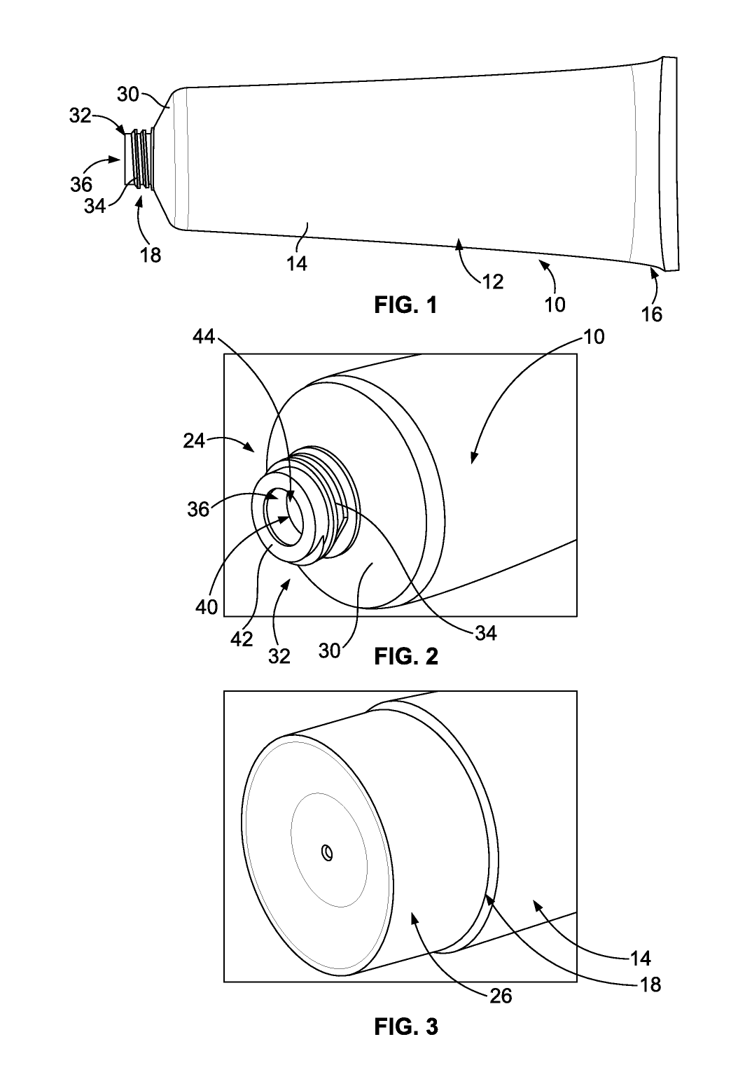

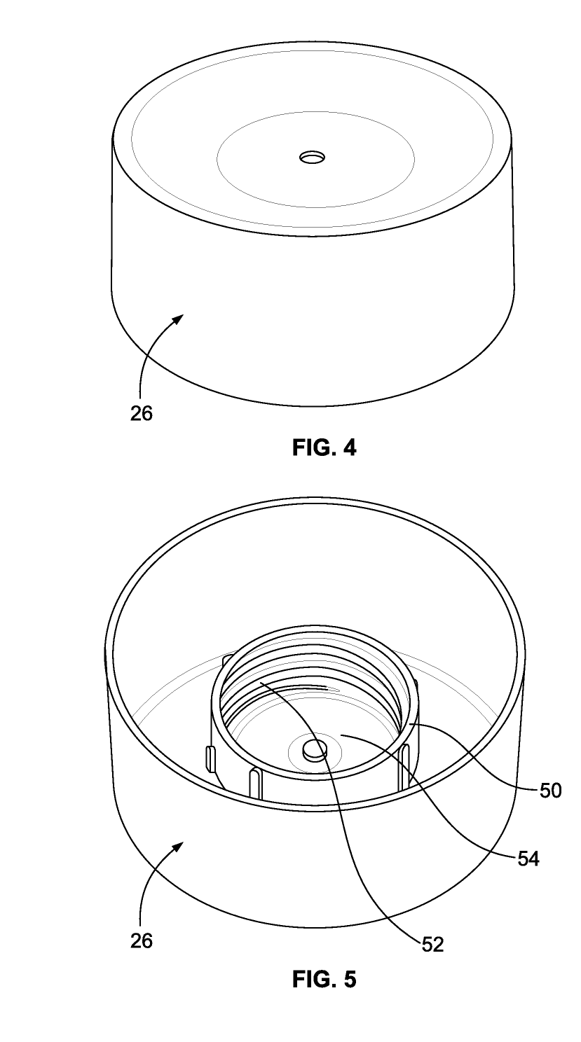

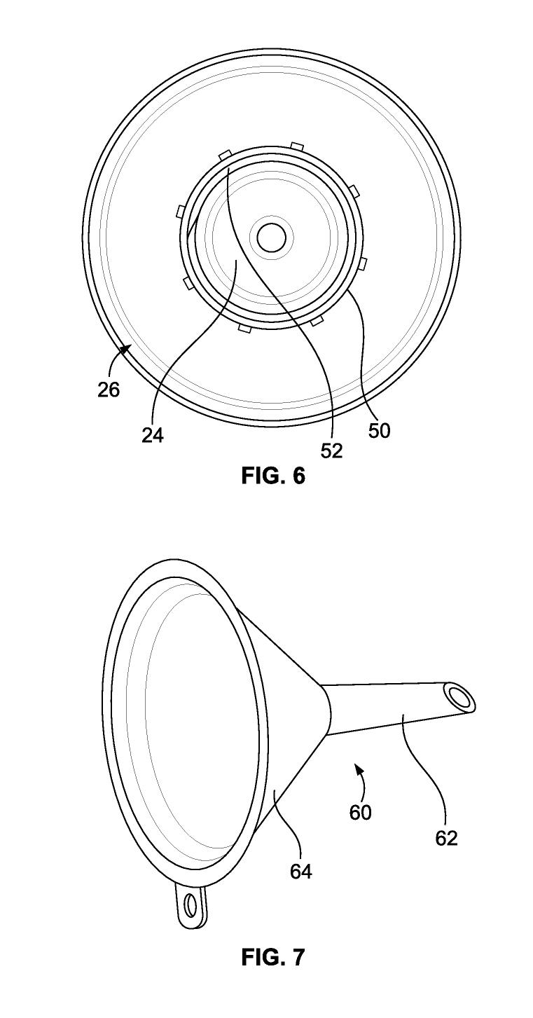

### DETAILED DESCRIPTION

Referring to the Figs., a device 10 for containing, storing, transporting, and dispensing of potable fluids, wherein said device 10 disguises the contents thereof, is illustrated. In the present form, the device 10 has an external appearance that is generally that of a cosmetic products tube. That is, people are familiar with tubes for face cream or lotion, and sanitizer, etc. The present form of the device 10 is produced as a sunscreen lotion tube. As such, the device 10 has a body 12 including a tube portion 14 having a closed end 16 and an openable end 18. The device 10 is generally thermoplastic such that the closed end 16 may be heat-sealed. As is recognized by those familiar with cosmetics tubes, the body 12 is formed of a soft, elastically deformable plastic. The openable end 18 includes a dispensing portion 24 and a cap 26 for sealingly closing the device 10.

In the present form, the openable end 18 includes an end wall 30 from which a neck 32 having external threads 34 protrudes. The neck 32 terminates distally from the end wall 30 while defining an internal passage 36 therethrough. The passage 36 is in fluid communication with an internal reservoir 40 generally defined by an interior of the tube portion 14 and the end wall 30, as well as the neck 32, such that fluid is freely passable between each. The neck 32 further includes an annular wall 42 generally extending inwardly from the general perimeter threaded portion of the neck 32. The annular wall 42 defines an opening 44 through which fluid may be dispensed from or loaded into the device 10.

The body 12 is closed at the openable end 18 by the cap 26. That is, the cap 26 is constructed with a relatively common appearance while having an inner annular wall 50 with internal threads 52. The cap annular wall 50 terminates at an interior surface 54 formed on the cap 26. To seal the device 10, the cap threads 52 mate with the neck threads 34 to receive the neck 32 within the annular wall 50, preferably to a depth such that the neck annular wall 42 is pressed against the cap interior surface 54.

It should be noted that ordinary cosmetic tubes have a different construction. For instance, such tubes often have a flip cap with a post that is snappingly engaged within a hole for closing the tube, the hole otherwise permitting dispensing of cosmetic product. Ordinary cosmetic tubes generally contain thick, high viscosity, low volatility fluids such as creams. These fluids are dispensed judiciously in small amounts by applying pressure to the body of the tube. The present device 10 is constructed as to sealingly retain fluids which may be water-based or be liquor having an alcohol content where ordinary cosmetic tubes would permit leakage. Generally speaking, retaining such fluids is promoted by the present device by the threads 34, 52 having a smaller thread pitch angle and a deep thread depth, by the abutting of the walls 42, 50, and by such other details as would be known in the art. Additionally, the present device is designed to allow pouring of liquids, contrary to cosmetic tubes known in the art. Generally speaking, cosmetic products contained in tubes are frequently plastic fluids that require pressure to overcome a yield value, whereas pourable fluids do not. Therefore, the opening 44 is sized to permit pourable liquids such as water or alcohol-based products including liquor to pass without applying pressure to the body 12. Such pourable fluids may have a viscosity of 100 centipoise or less and preferably at 20 centipoise or less, at ambient temperatures such as approximately 50-80 degrees F. For instance, the opening 44 is approximately ¼″ in size or larger and, preferably, ½″ to 1,″ diametrally.

It should also be noted that cosmetic tubes generally are not for food or beverage. That is, it is known that plastics have a wide range of materials. Chemicals that are unhealthy or even carcinogenic leach out of plastics, particularly when in contact with other active fluids such as alcohol. Therefore, the present device 10 is entirely constructed of food-safe, food grade plastics. Again, the body 12 is preferably constructed of soft, elastically deformable thermoplastic.

The present device 10 further includes a loading device such as a funnel 60. In the present form, a funnel 60 is generally constructed with a first portion 62 that serves as a male portion receivable within the tube opening 44, and a second, conical portion 64 for receiving fluid for loading into the device 10.

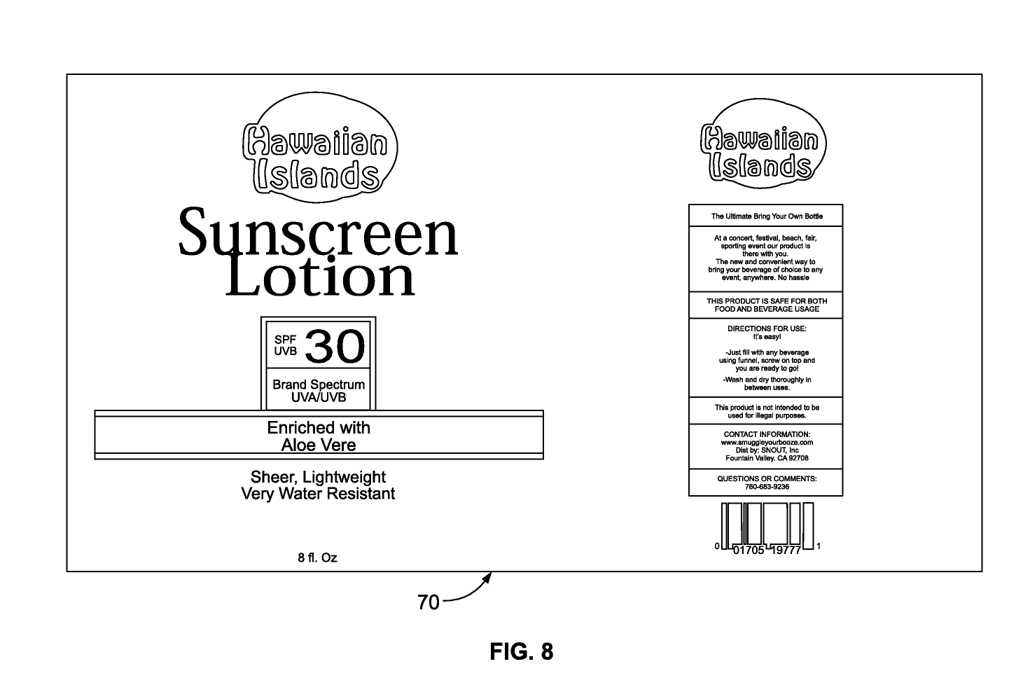

As can be seen in the Figs., the device 10 is packaged like a tube of sunscreen lotion, exemplary printed artwork 70 being shown in FIG. 8. As described, the opening 44 is sized to permit rinsing and cleaning of the device 10. Therefore, a person is able to re-usably fill and dispense fluid from the device 10, and is able to carry the device and its contents in public with a significantly reduced concern with other people recognizing or suspecting that the device contains potable liquid. Moreover, with the disguised packaging, another person would be misdirected from believing the device contains potable fluid. Again, ordinary cosmetics tubes have openings sized to allow for ease of rinsing and washing of the interior of the tube in a manner that is food safe.

While the invention has been described with respect to specific examples including presently preferred modes of carrying out the invention, those skilled in the art will appreciate that there are numerous variations and permutations of the above described systems and techniques that fall within the spirit and scope of the invention.

We claim:

1. An apparatus for containing and dispensing fluid, the device comprising:
a body having a sealingly closed end and an open end; and
a removable cap for sealingly engaging the open end, wherein the body is formed of elastically deformable food-safe plastic in a generally tubular shape, the closed end is heat sealed, the open end has an opening sized to permit pouring of fluid therefrom when the removable cap is dis-engaged therefrom, and the removable cap and open end include structure for sealingly engaging to prevent pourable liquid from leaking therebetween.

2. The apparatus of claim 1 wherein the opening of the open end is sized to permit pourable fluid of approximately 100 centipoise or less to pass therethrough in the absence of pressure on the body.

3. The apparatus of claim 2 wherein the opening of the open end is sized to permit pourable fluid of approximately 20 centipoise or less to pass therethrough in the absence of pressure on the body.

4. The apparatus of claim 2 wherein the opening of the open end is sized to permit pourable fluid in the form of alcoholic liquor to pass therethrough in the absence of pressure on the body.

5. The apparatus of claim 1 wherein the structure includes mating threads of a high pitch formed on the cap and the open end.

6. The apparatus of claim 1 wherein the body includes a sidewall opposite the closed end and neck extending from the sidewall, the neck defining the open end opening, and the neck including threads, and wherein the cap includes threads for sealingly mating with the neck threads.

7. The apparatus of claim 6 wherein the respective cap threads and neck threads have a high pitch angle to prevent low viscosity fluids from passing therebetween.

8. The apparatus of claim 7 wherein the high pitch angle is selected to prevent fluids of less than 10 centipoise at ambient temperatures from passing therebetween.

9. The apparatus of claim 1 wherein the opening is approximately ¼″ in diameter.

10. The apparatus of claim 1 wherein the opening is greater than ¼″ in diameter.

11. The apparatus of claim 1 wherein the body includes indicia of a cosmetic.

12. The apparatus of claim 1 wherein the body includes exterior indicia of lotion for protecting a person from sun.

13. An apparatus for disguising the contents thereof, the apparatus comprising:
a cosmetic-style appearance including,
a tubular body formed of elastically deformable food-grade polymeric material having a compressed and sealed closed end and an exterior surface bearing indicia of a common cosmetic and an openable end, and
a closure for engaging with the openable end having a first position for allowing dispensing of a pourable fluid at ambient temperature and a second position for preventing of dispensing of pourable fluid.

14. The apparatus of claim 13 wherein the body has a neck with threads and the closure has internal threads for mating with the neck threads to prevent generally the pourable fluid from passing therebetween.

15. The apparatus of claim 14 wherein the closure has an internal wall, the neck has an endwall extending radially inwardly to define the opening, and the second position includes the internal wall engaging with the endwall to restrict passage of the fluid therebetween.

16. The apparatus of claim 13 wherein the first position is defined by disengagement of the closure from the body, and the body includes an opening sized to permit pourable fluid to pass therethrough without significant pressure applied to the body.

17. The apparatus of claim 16 wherein the opening is approximately ¼″ .

18. The apparatus of claim 16 wherein the opening is greater than ¼″ .

19. The apparatus of claim 14 wherein the appearance includes indicia of a product for reducing effects of sun.

20. An apparatus for disguising the contents thereof, the apparatus comprising:
a tube having a cosmetic-style appearance, the tube including,
a tubular body formed of elastically deformable food-grade polymeric material having a compressed and sealed closed end and an exterior surface bearing indicia of a common cosmetic and an openable end, and
a closure for engaging with the openable end having a first position for allowing dispensing of a pourable fluid at ambient temperature and a second position for preventing of dispensing of pourable fluid; and
a loading device in the form of a funnel, wherein the closure and tubular body are engageable in the second position to prevent pourable fluid contained therein to pass therebetween, the closure and tubular body are dis-engageable in the first position to permit fluid to pour from the openable end, the loading device is sized to cooperate with the openable end for loading of pourable fluid into the tubular body, and the openable end is sized to permit pouring of fluid therefrom and sized to permit cleaning of the interior of the tubular body.
